(19) United States
(12) Patent Application Publication
(10) Pub. No.: US 2023/0026945 A1
(43) Pub. Date: Jan. 26, 2023

(54) Virtual Conversational Agent

(71) Applicant: Wellspoken, Inc., Palo Alto, CA (US)

(72) Inventors: Meir Friedlander, Palo Alto, CA (US); Vladimir Jovanovic, Belgrade (RS); Eitan Lev, Even Yehuda (IL)

(21) Appl. No.: 17/382,182

(22) Filed: Jul. 21, 2021

(51) Int. Cl. G06F 40/30; G06N 3/04; G06N 3/08

(52) U.S. Cl. CPC G06F 40/30; G06N 3/0454; G06N 3/08

(57) ABSTRACT

Methods, systems, and apparatus, including computer programs encoded on computer storage media, for generating and operating voice conversing virtual agents with pre-modeled and inherited human behavior across use cases and domains. One of the methods includes: using a first non-domain specific neural network based model to predict a non-domain specific conversational situation, the first neural network based model trained with labelled parts of conversations from more than one domain; forwarding the non-domain specific conversational situation to a second domain specific neural network based model; using the second domain specific neural network based model to predict a conversational situation and to provide a system intent, the second domain specific neural network based model trained with labelled parts of conversation from a specified domain; and generating a response based at least in part on the predicted conversational situation and system intent.

### BACKGROUND

### Technical Field

This specification relates to generating and operating voice conversing virtual agents.

### Background

There are several services that allow customers to create applications that can conduct a domain specific voice conversation with a user. Such services lack the ability to handle unscripted situations in a natural generalized manner.

### SUMMARY

This specification is directed to method(s) and system(s) for generating and operating voice conversing virtual agents with pre-modeled and inherited human behavior across use cases and domains.

Customers of the service described in this specification may use its interface to create domain specific applications for their users, having the ability to make real life conversations where the application understands the contextual situations, mimics human responses and progresses the unscripted flow.

The described service is highly efficient for model training and can handle real life voice conversations, due to the usage of two separate neural network models for predicting the optimal next situation and then the application response.

The first model is for handling the “non domain-specific related” parts of the conversation, which can include generic human voice conversational behavior. This model is used by all the applications created by the service.

The second model is “domain related” and handles the parts of the conversation that are particular to a specific task for a specified domain. Such a model may serve only one specific application generated by a customer of the service or may be shared by several customers who generate multiple applications in the same or similar domains.

In general, one innovative aspect of the subject matter described in this specification can be embodied in methods that include the actions of: using a first non-domain specific neural network based model to predict a non-domain specific conversational situation, the first neural network based model trained with labelled parts of conversations from more than one domain; forwarding the non-domain specific conversational situation to a second domain specific neural network based model; using the second domain specific neural network based model to predict a conversational situation and to provide a system intent, the second domain specific neural network based model trained with labelled parts of conversation from a specified domain; and generating a response based at least in part on the predicted conversational situation and system intent.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Embodiment one provides that a situational conversation manager can include the first non-domain specific neural network and the second domain specific neural network and the can method further include: receiving processed text at a dialog manager wrapper, the processed text received from a natural language understanding module; enriching the processed text with data retrieved from external sources to produce enriched processed text; and forwarding the enriched processed text to the situational conversation manager. Embodiment two provides that generating a response can include: determining, using a dynamic intelligent response template classifier, a set of best candidate dynamic intelligent response templates with a representation closest, according to a similarity metric, to a representation of a context of the conversation; filling in, using a dynamic intelligent response realizer, variable fields for at least some of best candidate dynamic intelligent response templates to generate a set of dynamic intelligent response realizations; scoring, using a dynamic intelligent response realization scorer, at least some of the set of dynamic intelligent response realizations based on the closeness of the representation of a dynamic intelligent response realization, according to a similarity metric, to a representation of a context of the conversation to produce dynamic intelligent response realization scores; and generating a response based at least in part on the dynamic intelligent response realization scores.

Embodiment three provides that a situational response generator can include the dynamic intelligent response template classifier, dynamic intelligent response realizer and dynamic intelligent response realization scorer. Embodiment four provides that the method can further include determining user emotional quotient and providing that to the situational conversation manager. Embodiment five provides that the method can further include determining behavioral triggers and providing that info to the situational conversation manager. Embodiment six provides that a dialog manager enhancer can determine the user EQ and the behavioral triggers, wherein a dialog manager wrapper can include the dialog manager enhancer and the situational conversation manager and wherein the method can further include receiving at the dialog manager wrapper contextual shell data. Embodiment seven provides that the contextual shell data can include system contextual shell data and customer contextual shell data. Embodiment eight provides that forwarding the non-domain specific conversational situation to a second domain specific neural network based model can include forwarding an initial system intent prediction. Embodiment nine provides that the method can further include: determining that the prediction of non-domain specific situation is part of a system situational bucket; determining that the system situational bucket is part of a customer specific bucket; and based on determining that the system situational bucket is part of a customer specific bucket, using the second domain specific neural network based model to predict a conversational situation and to provide a system intent. Embodiment ten provides that the method can further include: determining that the non-domain specific situation is part of a customer specific bucket; and based on determining that the system situational bucket is part of a customer specific bucket, using the second domain specific neural network based model to predict a conversational situation and to provide a system intent.

Embodiment 11 is directed to one or more computer-readable devices having instructions stored thereon, that when executed by one or more processors, cause the performance of actions according to the method of any one of embodiments 1 through 10.

The subject matter described in this specification can be implemented in particular embodiments so as to realize one or more of the following advantages. Systems and methods described in this specification shorten design, implementation and maintenance of applications based on the service(s) and increase usability and adoption of such applications.

Systems and methods described in this specification make it easier to design more comprehensive digital conversations. For example, systems and methods described in this specification can handle multiple subject/task conversations with context changes, while maintaining some of the context and history of the conversation, e.g. calling the bank for multiple money transfers, credit card operations and asking a few questions. Systems and methods described in this specification can handle longer conversations involving complex tasks with interruptions. Systems and methods described in this specification make it easier to change and maintain use case specific situations without having to change the way basic (e.g., non-domain specific) human behavior is handled. Systems and methods described in this specification resolve conversational conflicts (in a manner not perceptibly different than the way a human would do so). Systems and methods described in this specification enable real-time simulations during application design and build (e.g., they provide “What You Hear is What You Get” simulations). Systems and methods described in this specification enable domain specific contextual shells (customer defined macro complex situations) with inherited basic human behavior, e.g. FAQ, advertisements (inheriting wait, stall, skip, rephrase, etc.) facilitating the scaling of voice application development. Systems and methods described in this specification reduce the amount of required data for training of customer models (referred to below as a neural network 2 or NN2 model). Because of the architecture described in this specification, there is a limited, or no, need to train the basic human behavior model. Systems and methods described in this specification enable the handling of complex situations, including cross subject FAQs and Advertisements.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating a system and environment for providing a service to generate virtual agents with human like behavior.

FIG. 2 is a data flowchart illustrating the data propagation in the system during real time activity.

FIGS. 3 and 3a are block diagrams illustrating the main components of a contextual shell.

FIG. 4 is a flowchart illustrating the training process of the neural network based Humanized model.

FIGS. 5a, 5b and 5c are flowcharts that illustrate how situational buckets are generated in the system.

FIG. 5d is a block diagram illustrating the main components and processes in the Dialog Manager Wrapper (DMW).

FIG. 5e is a flowchart of the process that runs in the Situational Conversation Manager (SCM) sub-system for predicting the situation and intent to be used by the system for optimally generating its next utterance.

FIG. 6 is an example of a possible conversation between a user of the described system and a virtual assistant.

FIG. 7 describes an exemplary process in the SCM that may take place as a result of user utterance such as “Sorry, I didn't catch that?”, which appears in step 4 of the conversation of FIG. 6.

FIG. 8 is another exemplary process in the SCM that may take place as a result of the user utterance “Great, connect me to them”, which appears in step 6 of the conversation of FIG. 6.

FIG. 9 is a data flowchart illustrating the data augmentation process in the system.

FIG. 10 shows the edit flow for a Dynamic Intelligent Response (DIR) template.

FIG. 11 shows the different sources for DIR template candidates for a DIR editor.

FIG. 12 is a flowchart of the process that runs in the Situational Response Generator (SRG) sub-system for choosing and realizing a DIR due to the SCM situation and intent prediction.

FIG. 13a is a flowchart of the process that runs in the DIR template classifier sub-module of the SRG.

FIG. 13b is a flowchart of the process that runs in the DIR realization selector sub-module of the SRG.

FIG. 13c is a flowchart of the process that runs in the DIR realization scorer sub-module of the SRG.

Like reference numbers and designations in the various drawings indicate like elements.

### DETAILED DESCRIPTION

There are several services that allow customers to create applications that can conduct a domain specific conversation with a user.

One major disadvantage of these services is that the dataset used to train a domain specific model does not include the pure “human behavior”, “out-of-domain” related parts of a conversation. Indeed, these parts are excluded on purpose from the conversations during the training process. This exclusion causes applications generated by such services to lack the ability to successfully handle verbal “human behavior,” unscripted situations.

Implementations of the service described in this specification take care of the “human behavior” related situations by using a module comprised of one or more neural network (NN) model(s) different than domain specific model(s), and based on a large dataset that covers numerous conversations and situations. These model(s) are trained and maintained by the service. With regard to what is a large dataset, to build a comprehensive model from scratch one could use hundreds/thousands of system situation (SS) and system intent (SI) combinations represented by parts of conversations. 100-500 real examples for each situation. In one case, a service described in this specification can train a generalized neural network (NN1) for handling non-domain specific situations, with 10-20 real conversations augmented and combined with a few generic and anonymized neural network 2 (NN2)-like parts of conversations, where NN2 is a model to handle domain specific situations. Any newly introduced NN2 situation could be developed by training with 10-20 real conversations, augmented with 100-500 conversations relevant to the new situation. NN1 can handle at least the following situations:

1—basic human behavior (e.g., “wait [pause], I didn't get that”), “I have a question”, “can you explain further”),
2—Common complex macro-situations, that need a fallback if not defined well such as FAQ, disclaimer, advertisements, greetings, collecting user's name scenarios.
3—Resolving known conflicts for small training data for NN2 (e.g., defining 3 stop scenarios), i.e., 1) a stop reading situation, 2) a stop=wait situation, and 3) a stop the conversation situation.

The customer domain specific models need to handle only the domain specific parts of the conversation. The “human behavior” related parts are taken care by the service's “human related” model.

This structure of datasets and models, separating between domain specific and human behavior related parts of a conversation, makes the described service superior to other existing services, both by shortening design, implementation and maintenance of applications based on the service (s) and by increasing usability and adoption of such applications.

### Terms

Following is a list of terms that are relevant to the described system.

### Conversation

An interaction between the user (consumer if B2C) and the Virtual Assistant (VA).

Composed of multiple turns, each turn composed of inbound (user) and outbound (bot) responses e.g., utterances or decision to remain silent as a response.

Turns are usually initiated by the user, but can also be initiated by the VA.

### Conversation Domain

The sectorial contextual environment that wraps a conversation, e.g. Healthcare, Sports, Travel, and Financial Services.

Domains have hierarchies and a conversation may be relevant to more than one Domain.

### Conversation Task

The main topic/use case/task of the conversation, e.g. ordering food for takeout, making a reservation, transferring money, etc.

### Conversational Slots

A list of slots/attributes corresponding to the entities present in the conversation by the user, e.g. “user last name”, “number of guests in a reservation”, etc.

The slots are provided by a 3rd party Natural Language Understanding (NLU) as part of the user utterances.

For example, slots can include:
name—the name of the slot.
description—a natural language description of the slot.
is_categorical—a boolean value. If it is true, the slot has a fixed set of possible values.
possible_values—List of possible values the slot can take. If the slot is a categorical slot, it is a complete list of all the possible values. If the slot is a non categorical slot, it is either an empty list or a small sample of all the values taken by the slot.

An example for a slot in a business directory application follows:
name: department
description: . . .
is_categorical: true
possible_values: [sales, finance, helpdesk]
Or
name: price
is_categorical: false

### Conversation Turn

A coupled “user said—VA said” utterances. A conversation may have one or more turns.

### Conversation Phase

Part of a conversation with a common topic. For example the authentication phase of the conversation. A conversation may contain one or more phases. A conversation phase may contain one or more “parts of dialog”.

### POD (Part of Dialog):

Part of the conversation, typically refers to one situation within a conversation. May contain one or more conversation turns. Typically a POD includes one or more utterances or conversational turns, the entry turn into the part of dialog and the exit turn.

PODs may overlap with more than one situation, for example when a System Situation is fully included within a client situation:
System: what is your wife's date of birth
User: wait a second, I need to check
. . . (2 minutes)
User: OK, I have it
System: OK, and the date is?
User: . . .
System, thanks, next question, . . .

### Contextual Shell

A container that includes all the necessary conversation behavioral data and metadata required to roll conversations for a set of related conversational use cases.

Contextual shells may be domain specific (e.g. banking, hospitality, healthcare) or subject/brand specific (e.g. on-line shopping, greetings-that-work).

Contextual shells support both hierarchies and inclusion.

Typically, a contextual shell includes conversation-related behavioral and linguistic rules and guidelines, dictionaries and lexicons, situations, related Dynamic Intelligent Responses (DIRs), internal and external variable data.

At the lower level of the hierarchy, a contextual shell can either represent a single use case, potentially including flow examples, or just a container library for any set of the contextual shell elements above: situations, rules, DIR templates, etc.

A contextual shell includes voice persona guidelines for all the situations included in that Contextual Shell. For example, the voice(s) to use, the default style, supported tones, behavioral rules, etc. A contextual shell can include references to other contextual shells out of its hierarchy and its inherence path through inclusion.

At lower-level contextual shells, it is possible to override the configuration or the details of situations inherited from higher levels.

### Situation

Situation is the basic state in the conversational management state machine, handling a single turn within a conversation.

The situation specific behavior is defined in the situational trained model by the rules and parameters at its contextual shell container, the contextual data, including specifically the user intent, the enabled system intents and possible DIR templates.

A situation may be defined as part of a (sample) flow, parts of conversations, or by its components

### System Situation

System situations (and system intents) represent the non-domain specific human conversational behavior.

Examples of system situations:
Unplanned stall
Wait
Stop
Context_summary
Calm_user_down
Cheer_user_up
Generic_context_switch
Discover_name (discover user's name through conversation)

### Customer Situation

Customer situations represent business conversational specific guidelines.

Examples of Customer situations for a directory conversational voice application:
Greeting
Stall
Who_am_I_speaking_with
Discover_business_by_name
Discover_business_by_type
Discover_business_by_product
Frequently Asked Questions
Conversation hand over
DTMF over
Goodbye

### Situational Bucket

Situational buckets are groups of situations, which are created during system design in these cases where an overlap between several defined situations is identified.

In cases where the system predicts the system situation for its coming reaction, and the situation is part of any defined situation bucket, the system will eventually choose a situation from the bucket, which may be different from the original prediction.

The system may have two types of situational buckets:

A System bucket is a situational bucket which contains only system situations.

A NN2 bucket is a situational bucket which contains both system situations or a system bucket, and one or more customer situations.

Each System Situation may have entries in two hash tables, mapping it if needed to a situational bucket:
System buckets hash table (the mapping function of the hash table can be achieved using other mapping mechanisms): contains mapping from System Situation to a System Bucket (if such a mapping exists).
All buckets hash table: contains mapping of system situations into a NN2 bucket.
   Examples for buckets:
Greeting_Bucket
Goodbye_Bucket
Generic_Help_Bucket
Context_summary_Bucket
Read_long_info_Bucket
FAQ_bucket
Other_Customer_Situation_Bucket: this is a special bucket which encapsulates for the system all the situations that were defined by a customer.

### System Intent

System intents represent basic “common” human conversational behavior simulated by the system. They are human-like basic conversational behavioral built-in rules that are use case agnostic. System intents are part of the context, decided by SCM and an important part of the DIR generation (selection and realization) model.

System intents are invoked by a user reaction at the “lower level” of the situation the user is currently in, or by the platform (e.g., unexpected response from 3rd party, need to buy time due to extended response time.)

System intents are internal. However, they may be customized by contextual shells' parameters and rules. They may be enabled/disabled at the Contextual shell or citation levels.

Examples of system intents:
Say (default)
Rephrase
Repeat_louder
Repeat_clearer
Confirm_action
Check_name
Contextual help
Resume_conversation
Previous_item
Next_item
Repeat last
Resume reading
Apologize
Read_long_info

### Conversation Behavioral Trigger

One or more triggers calculated by the Dialog Manager Wrapper, typically based on the user speech signal analysis. Can be of two types—User EQ (User emotional quotient, the system's determination of a user's set of mind, emotional/mood conditions) or Environmental trigger. The Behavioral Triggers are used as input to the Situational Conversation Manager (SCM) and Situational Response Generator (SRG) neural networks.

### Conversational Environmental Trigger

The dynamically calculated environmental status of the conversation, measured by a Dialog Manager Wrapper based on Automatic Speech Recognition (ASRs) outputs and audio signal analysis.

Examples: Silence, parking lot background noises, multiple speakers, driving, bad connection, and rain noises.

### User Emotional Quotient (EQ):

The system's determination of a user's set of mind, emotional/mood conditions. Decided by the Dialog Manager Wrapper based on the audio signal analysis but may also depend on NLU(s') or ASR(s') outputs.

Unlike user intent, user EQ is not measured by current open NLUs, but they may support some EQs in the future. User EQ can be used as an input to the SCM and to the SRG. User EQ and conversational triggers can be calculated by implementations of the service described in this specification and can be based on the actual audio of the conversation.

Examples: Frustrated, Misunderstood, mumbling/unclear, Confused, Incoherent, Preoccupied/unengaged, Happy, Sad, Angry, Nervous, screaming/yelling, and stubborn.

### DIR—Dynamic Intelligent Response

A possible utterance that was generated by the system to be said by the VA.

### DIR Template

A parametric possible VA utterance template, which belongs to a contextual shell and typically related to one or more situations.

DIR templates are constructed with text, prosodic instructions at the lower level, and tags and descriptors at the mid-level.

Prosodic instructions include tone changes, gestures, local changes in pitch, volume, emphasis, etc.

Mid-level tags can include the recommended tone, level-of-language, and gender of user sensitivity.

DIR templates are sensitive to the contextual rules as defined in the contextual shell.

All parts of DIR templates may be fixed or variable including the prosodic parts.

There are several ways to create a DIR template:
manually from scratch using the DIR editor.
by duplicating and then editing an existing DIR template.
generated from actual conversations' recordings utilizing AI methods and some manual work.
driven by flows (designed with system tools or imported from other tools or old interactive voice response systems, e.g., from lists of possible responses stored in legacy system(s)).

### ASR

Automatic Speech Recognition. Conversion of spoken words to interpretable text.

### NLU

Natural Language Understanding. Speech recognition techniques that permit a user to use full phrases and sentences, as in everyday conversation. Typically, natural speech is longer in duration and may have a broad range of possible meanings. A grammar (or model) capable of natural language understanding accepts a wide variety of different user utterances.

### Dialog Manager

In a situational based voice application, typically a state machine that manages the flow of the voice application, including various dialog states, primary paths of informational exchanges, transaction outcomes, and decision logic. A typical DM is strongly connected to the NLU, and sometimes also to the TTS and to external systems.

### NLU Confidence Score

Value assigned as a measure of the NLU engine's confidence that it can correctly identify the user intent, sentiment of a user utterance. The higher the score, the more likely it is that the result matches what the user meant. Some NLU engines return only the highest scored user intent and some return the top n.

### IVR

Interactive Voice Response. General-purpose system for developing and deploying telephony applications that perform automated operations and transactions to callers primarily via simple voice commands and DTMF (Dual Tone Multi Frequency, also known as touchtone) input.

### Dialog Manager Wrapper

A consistent wrapper around multiple 3rd parties' voice dialog managers/NLU components, that enhances the output of the 3rd party Dialog Managers, manages the independent conversational situational state machine, including history and CRM integrations, and executes the SCM (Situational Conversation Manager) module, for predicting the next system situation and intent in a conversation.

### Dialog Manager Enhancer

Part of the dialog manager wrapper that enriches the output of 3rd party Dialog Managers, by extracting additional information from the ASR text, NLU output, CRM data, the actual audio signal, and the contextual shell data, providing the additional information as additional inputs to the Situational Conversation Manager (SCM)

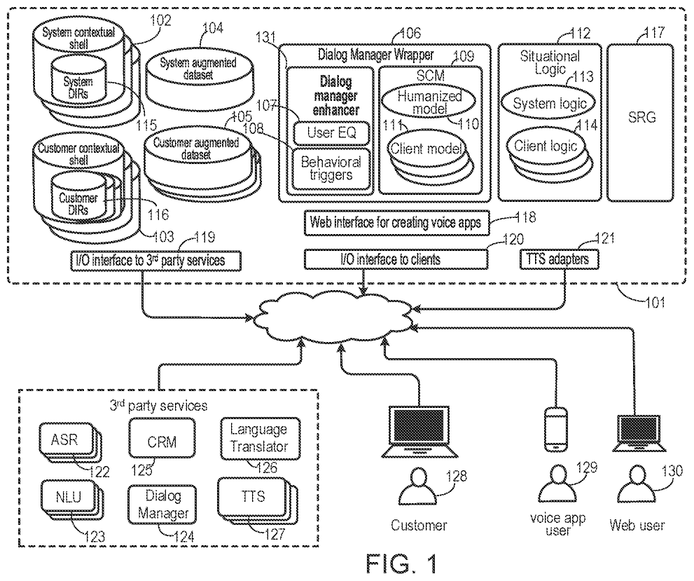

FIG. 1 illustrates the main blocks of the system 101 and the high level relationship between them. Contextual shell—a domain specific hierarchical container that includes all the necessary conversation behavioral data and metadata required to roll conversations for a set of related conversational use cases. The system has built-in contextual shells 102, and a customer may create new contextual shells 103 based on existing ones or from scratch.

System and Customer augmented datasets 104 and 105—datasets that contain multiple conversations, either imported into the system or generated in it by a combination of automatic and manual means. These datasets are used to train the neural networks of the system.

Humanized augmented dataset—a dataset used to train and improve the Humanized model.

Customer augmented dataset—a dataset prepared by the customer for training and improving a customer model.

Dialog Manager Wrapper (DMW) 106—This module acts as a consistent wrapper around multiple voice dialog managers/NLU components from 3rd parties.

The DMW manages an independent conversational situational state machine, including history and Customer Relationship Manager (CRM) integrations. It also hides and unifies dialog manager access. In certain embodiments, system users can access 3rd party engines through the system's platform UX and/or APIs.

The DMW has two main roles:
Enriching the output of a 3^{rd} party Dialog Manager, which is connected to the system; and
Running the SCM (Situational Conversation Manager) module, for predicting the next system situation and intent in a conversation.

The Dialog Manager enhancer 131 module tracks additional information such as user EQ 107 and behavioral triggers 108 derived from text, NLU 123, CRM 125, audio signal data and contextual shell data 102 and 103, providing them as inputs to the SCM module 109.

SCM (Situational Conversation Manager) 109—a system module, which runs the system humanized model and a specific customer model. The SCM is responsible for predicting the best situation and system intent for the coming system response, based on its input and history.

Humanized model 110—can be a neural network based model (e.g., a seq2seq model), aimed to predict only system situations and intents which are domain and customer agnostic. Seq2seq is a family of machine learning approaches used for language processing. The Humanized model is trained with real or synthetic conversations, with the parts that include general human behavior utterances.

Customer model 111—can be a neural network based model (e.g., a seq2seq model), aimed to provide the final situation and intent prediction for the current situation. This model gets the same input as the Humanized model, as well as the temporal prediction of the Humanized model. The model is trained with domain specific conversations, real or synthetic.

Situational Logic 112—a system module, responsible for preparing the input for the SRG module according to the predictions made by the SCM, performing actions before SRG, activating SRG and performing actions afterwards. It includes and handles the system's situational logic 113, provided for system situations, as well as client situational logic 114, defined by clients to take care of client situations.

System DIRs 115—DIRs provided by the system, covering domain agnostic situations. A DIR (Dynamic Intelligent Response) is a possible utterance to be said by the system. The DIR is generated from a DIR template, which is parametric, belongs to a contextual shell and is typically related to one or more situations. DIR templates are constructed with text, prosodic instructions, and tags which include the recommended tone, level-of-language, and gender of user sensitivity. DIR templates are sensitive to contextual rules defined in the relevant contextual shell.

Customer DIRs 116—DIRs provided by a customer, covering domain related situations, but may also cover domain agnostic situations.

A SRG (Situational Response Generator) 117 is a system module which incorporates several Neural Network (NN) based Machine Learning (ML) models, responsible for selecting and realizing the most appropriate DIR realization that corresponds to a DIR template from a contextual shell, for the next system utterance.

The SRG includes ML based modules. All three modules use context as inputs to their ML models during their prediction process.

Context is produced in a similar way to what is done in the SCM module. It has history of past:
DMW data
selected Situations and System Intents
selected DIR templates and DIR realizations.

This data can go through context-specific and/or module-specific compression before entering the NN models.

Apart from the ML processes described below, each module can use hardcoded rules in its decision making.

These are the three ML modules of the SRG:

1. DIR Template Classifier:

This module can use two joined sequence-to-sequence (Seq2Seq) neural network models, each producing an embedded representation of its input sequence. The Seq2Seq models are transformer/attention-based models. The hyperparameters are architecture- and dataset-based. The first NN model takes current context as its input, and the second uses candidate DIR templates as inputs. The current context can be based on a variety of inputs such as: the text of the conversation; audio signal information, the system's NLU, third-party NLU, CRM data, and contextual shell data.

The two representations are compared using a similarity metric. By comparing the two representations using a similarity metric, each candidate DIR template is compared to the current context. Representations are embeddings (points in N-dimensional space). The similarity metric is a distance metric between two points (e.g. cosine or Euclidean).

In one implementation, a module selects the set of best candidate DIR templates with the representation closest (according to the similarity metric) to the representation of the context.

2. DIR Realizer/DIR Realization Selector:

This module maps a DIR template to a DIR realization by filling in variable fields of a DIR template.

It is run for top K DIR templates predicted by the DIR template classifier. Each DIR template is run (along with the context) through a sequence-to-sequence neural network model.

The model outputs the same DIR template but with all variable fields replaced by multiple sets of real values from the corresponding variables' domains. We call this a DIR realization—this will be the final prediction of SRG module.

This module generates M best DIR realizations for each of the K DIR templates.

A DIR realization can be a sequence of DIRs, and can be in the later stage split into individual DIRs, which will be processed by the TTS Adaptor.

3. DIR Realization Scorer:

This module works in a very similar way to the DIR template classifier module, with the difference that it works with DIR realizations.

Each of the K*M DIR realizations selected in the DIR realization selector module run through this module in order to re-calculate its score according to a similarity metric.

It calculates similarity scores between context and candidate DIR realizations. It uses a similar NN architecture as DIR template classifier, but is trained to use DIR realizations instead of DIR templates.

Final score for each candidate DIR realization is produced, which SRG uses to predict its final DIR realization.

The selected DIR realization and its DIR template are inserted back to SRG and SCM history for future predictions.

Web interface for creating voice apps 118—a set of web based tools, allowing a client to build his VA app from scratch, by selecting off-the-shelf service components, modifying them if needed and building new ones for situations which are not covered by the service libraries.

I/O interface to 3rd party services 119—this interface allows for data exchange with third party services.

I/O interface to clients 120—this interface allows interaction between clients and the system 1.

TTS adaptors 121—SW modules that make necessary adaptations of the system response to the actual TTS engine in use.

ASR 122—Automatic Speech recognition, converting speech to text.

NLU 123—Natural Language Understanding, converting text to a system-specific semantic representation.

Dialog Manager 124—a component in a dialog system, responsible for the state and flow of the conversation.

CRM 125—Customer Relationship Manager, responsible for providing additional data for identified users.

Language Translator 126—translates text from one language to another. In the described system, translates, if needed, the user utterance and the selected realized DIR from original language to the system language (English), and back from system language to the original language before passing it to the TTS.

TTS 127—Text to Speech module, converting text and prosodic+sentiment+persona definitions/instructions to speech.

Customer 128—a customer of the system, generating its unique VA app through the system's web interface.

App user 129—a user of the system who installed an app generated by a customer of the system, or alternatively a user who uses the system functionality thru a personal assistant having a connection to the system.

Web user 130—a user who uses the system functionality thru a web interface providing the functionality of the system.

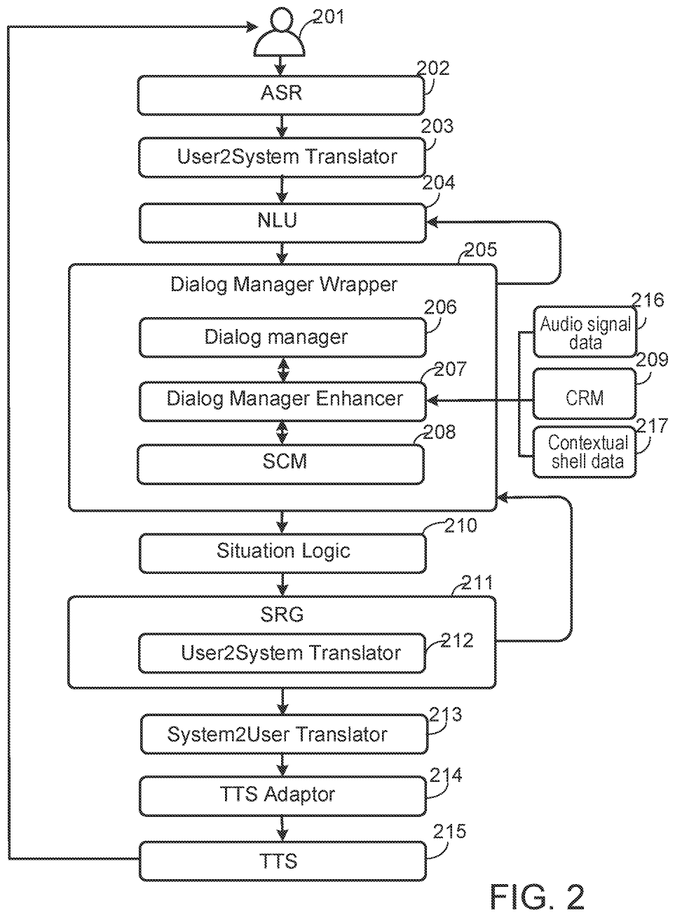

FIG. 2 illustrates the way data propagates in the system in runtime, from the moment a user says a sentence until he gets the system's response.

The voice of user 201 activates ASR 202, which converts the audio signal into text, in the native language used by user 201.

In order to have the text in the language the system uses for its internal operation, User2System Translator 203 translates the native language text into English. The Translator is optional, and the system can either support English input only or use the native language as the system language. In the absence of the translator, the system will support only one language.

NLU 204 gets the translated text and processes it, identifying and marking the keywords matching the slots it was programmed to find. Then it passes its findings to Dialog Manager Wrapper (DMW) 205.

DMW 205 operates a 3^{rd} parry Dialog Manager 206 for the basic understanding of the user intent and for the prediction of the system response. DMW 205 also maintains its own state machine and keeps the history of its activity.

DMW 205 enriches the data received from NLU 204 with additional data retrieved from external sources such as CRM 209, audio signal data 216 and contextual shell data 217. It interacts with Dialog Manager 206 for updating its state machine if required.

Dialog Manager enhancer 207 processes data from ASR text, NLU 204, CRM 209, audio signal data 16 and contextual shell data 217 to extract new information, provided as additional inputs to the Situational Conversation Manager (SCM) 208.

Based on the data from Dialog Manager 206, saved history (not shown), the enriched data and the updated state machine, DMW 205 operates Situational Conversation Manager (SCM) 208 for predicting the right situation and system intent.

DMW 205 passes the predicted situation and intent to Situational logic 210, which activates the logic related to the predicted situation and intent and makes all preparations required for the next step.

SRG 211 gets the data related to the prediction, and based on that finds the best system response (DIR) from the set of possible responses relevant for the predicted situation. SRG 11 also sends the selected best DIR to DMW 205 for storing it in its history.

If the responses are in a native language, SRG 211 uses User2System Translator 212 for translating the DIR from native language to system language, in order to be able to run the DIR selection algorithm.

The SRG 211 selects a set of DIRs with the highest probabilities to match the predicted situation. The prosodic parameters of the DIRs are set in several ways, and then the relevance probabilities of the realized DIRs are re-calculated. By the end of the process, the DIR with the best realization is selected as the system response. System2User translator 213 translates the selected DIR back to the native language.

TTS adaptor 214 is used to make necessary adaptations of the system response to the actual TTS engine 215 in use. If the user is using a virtual assistant which has an incorporated TTS, TTS adaptor 214 will adapt the DIR parameters for an optimal usage.

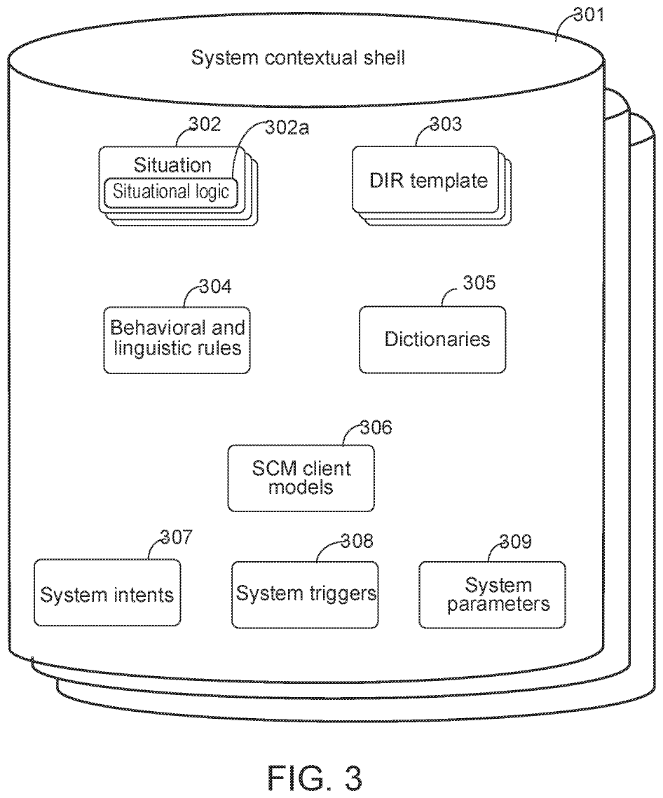

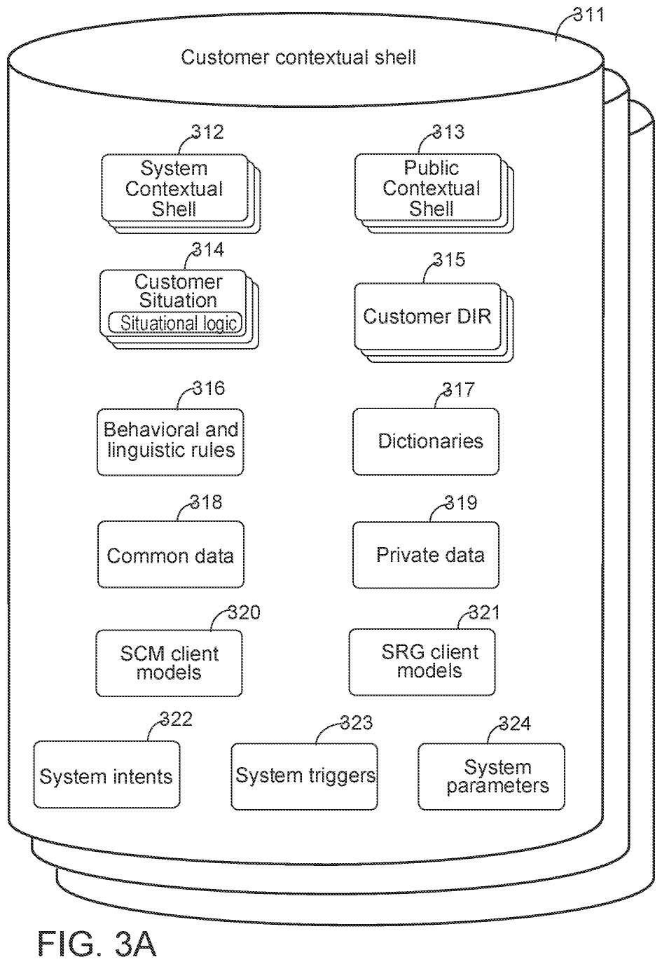

FIGS. 3 and 3a illustrate the main components of a system and customer contextual shells, respectively.

A contextual shell is a container that includes all the necessary conversation behavioral data and metadata required to roll conversations for a set of related conversational use cases.

The described system may include some built in contextual shells, that a customer may use for his specific system app as they are or make changes in them.

A system contextual shell 301 as described in FIG. 3 contains the following components:
System situations 302, including their situational logic 302a
System DIR templates 303
Behavioral and linguistic rules 304. Example for such rule: “when you explain to older people, speak slower”. For SCM/SRG training dataset, data augmentation will augment conversations that include the “rephrase”, “repeat” and “explain” System Intents or “user did not understand” User EQ, to include multiple contexts of “older people”, some with slower speaking responses.
Dictionaries 305
SCM models 306—system humanized models
System intents 307
System triggers 308
System parameters 309

A customer contextual shell as described in FIG. 3a contains the following components:
System contextual shells 312, including related situations and DIRs
Public/3^{rd} party contextual shells 313, including related situations and DIRs
Customer situations 314, with their situational logic
Customer DIRs 315
Behavioral and linguistic rules 316
Dictionaries 317
SCM client models 321
SRG client models 320
Common data 318, e.g. names of streets in the US
Private data 319, e.g. names of products with their correct pronunciations, CRM hooks.
System intents 322 (customer can enable or disable)
System triggers 323 (customer can enable or disable)
System parameters 324 (customer can enable or disable)

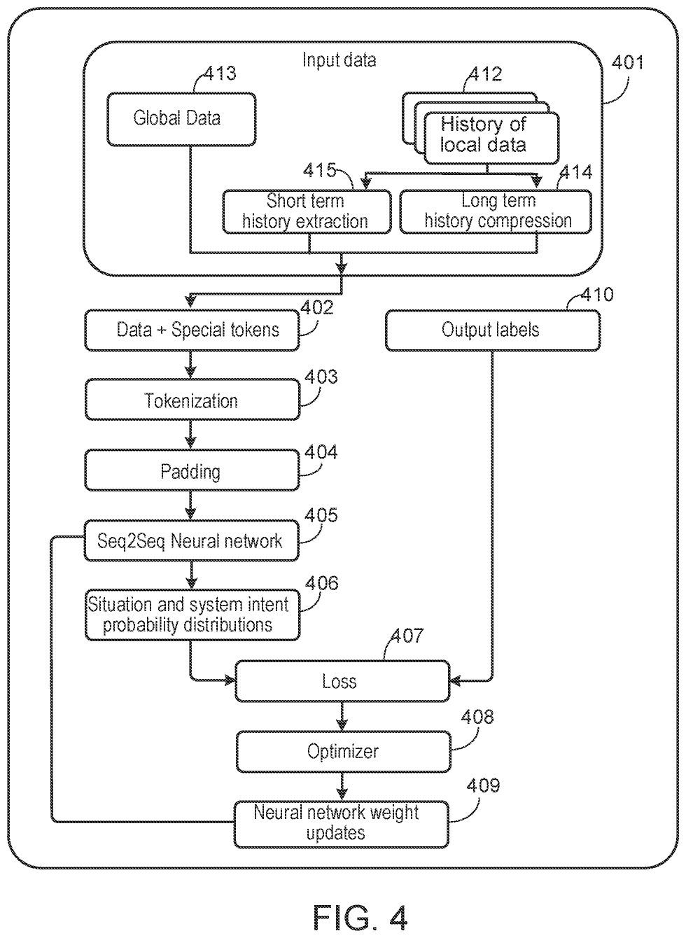

FIG. 4 is a flowchart illustrating a supervised training process of the neural network based Humanized model (element 10 in FIG. 1).

Input data 401 includes two types of data, related to the training conversations: local data 412 and global data 413.

Global data 413 contains all data that does not change between conversation turns, or data which does not have history in the system, such as the age and gender of a user or CRM data related to the user.

On the other hand, local data 412 is the dynamic data which may change during conversation turns, such as user EQ, user intent and audio parameters. There may be several sets of local data history, each of them related to a different turn in a training conversation.

During the training process, for efficiency reasons, a step of long term history compression 414 is executed in order to keep all conversation history in a compressed form. The compression involves extracting relevant parts of previous inputs, compressing (parts of) previous inputs into shorter (sequences of) tokens, or omitting previous inputs completely.

Long-term means history beyond the current turn/part of dialog.

Compression step 414 can work on multiple compression levels. In one implementation, pieces of history can be removed completely during compression.

Compression 414 can be procedural (interpretable/modifiable) or ML/NN-based. It can be context-specific, depending on short-term history (same long-term history data can be compressed in various ways—this depends on latest data).

At the same time, a step of short term history extraction 415 is executed, in order to make the short term history data available for the training process. Short term history can also be partially compressed, so extraction is not always relevant.

extracting the data from relevant previous turns (e.g. conversation phase or POD) can be fixed by number of turns, or can cover the close environment of the current PoD.

The rest of the process described in FIG. 4 is a training process of a machine learning model, based on a Seq2seq model which can be used in NLP applications. Other types of machine learning models can fulfill the requirements of this specification.

In step 402, the global and local data which is relevant for the training session is pre-processed and special tokens are inserted into it.

Afterwards, the steps of tokenization 403 and padding 404 are also executed to make the data ready for the training phase. Padding process here means resizing inputs to a fixed length and can include masking of padded parts of a sequence.

Seq2seq neural network 405 is activated for a pre-defined number of iterations.

In each iteration, the probability distributions of the output of the neural network—the system situation and system intent—are calculated in step 406.

Then, by comparing the probability distributions to the known output labels 410, loss 407 is calculated.

After two additional steps of optimizer 408 and weight updates 409, another iteration of training with the updated weights is performed. Optimizers are algorithms or methods used to change the attributes of the neural network such as weights and learning rate to reduce the losses. Optimizers are used to solve optimization problems by minimizing the function.

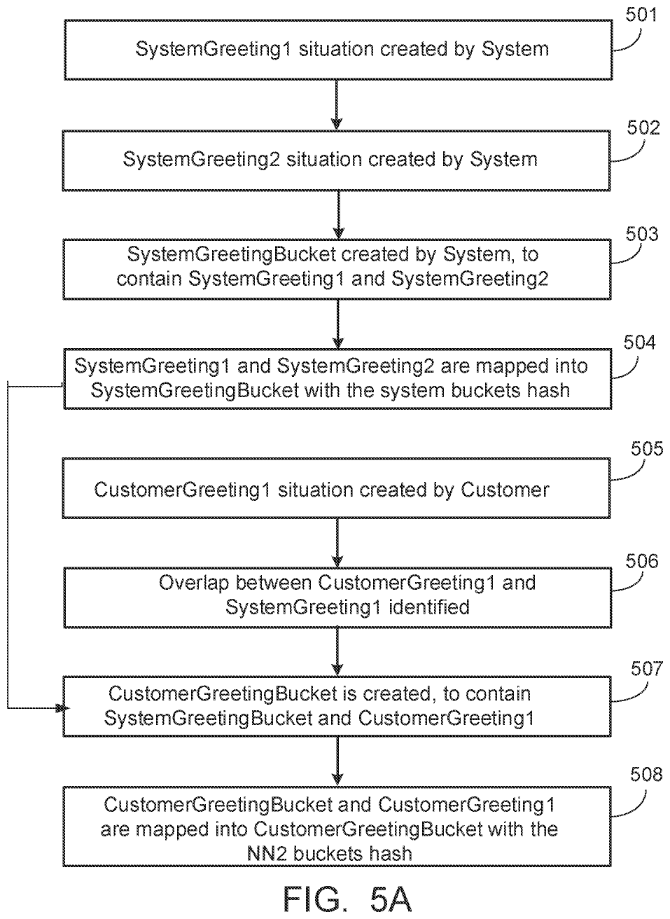

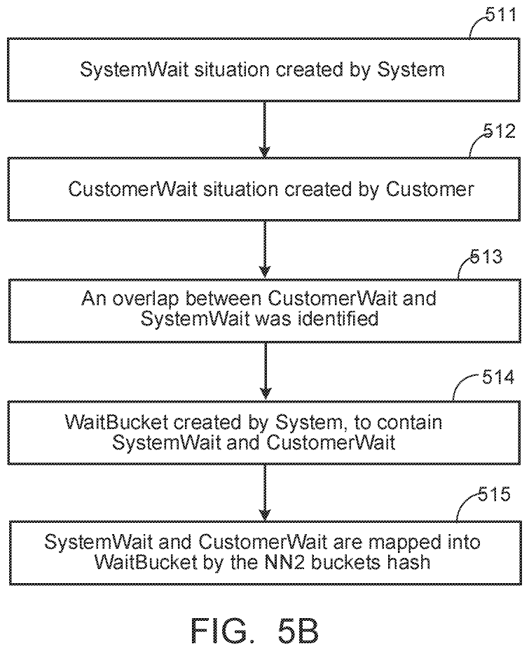

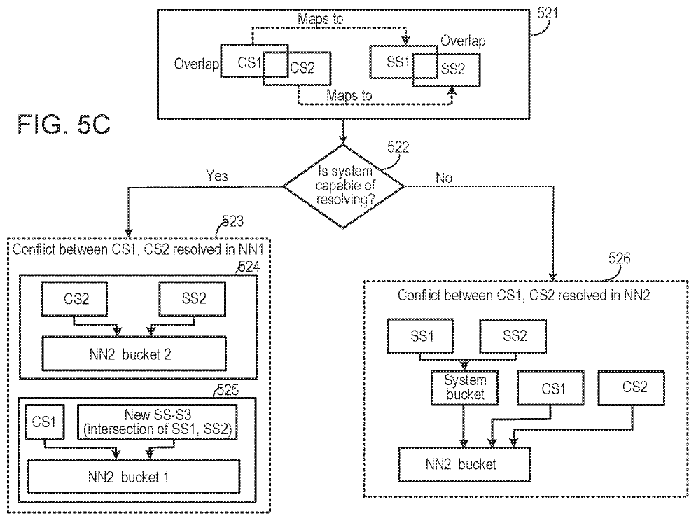

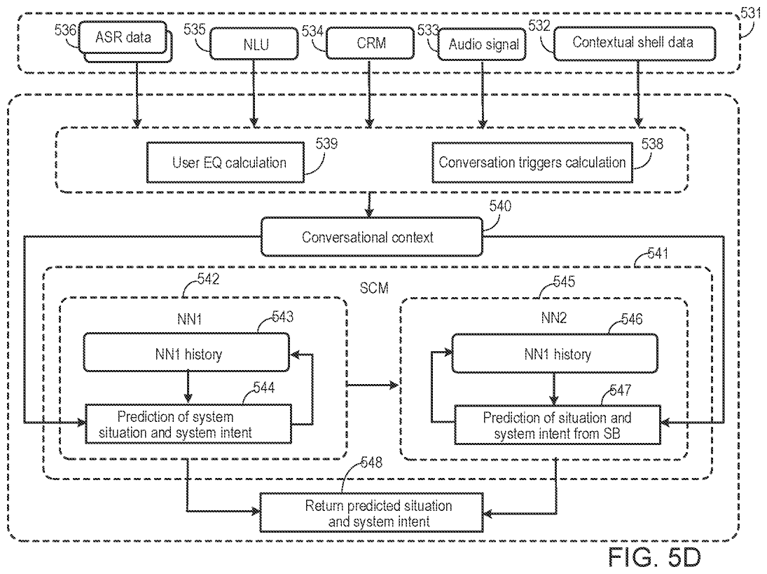

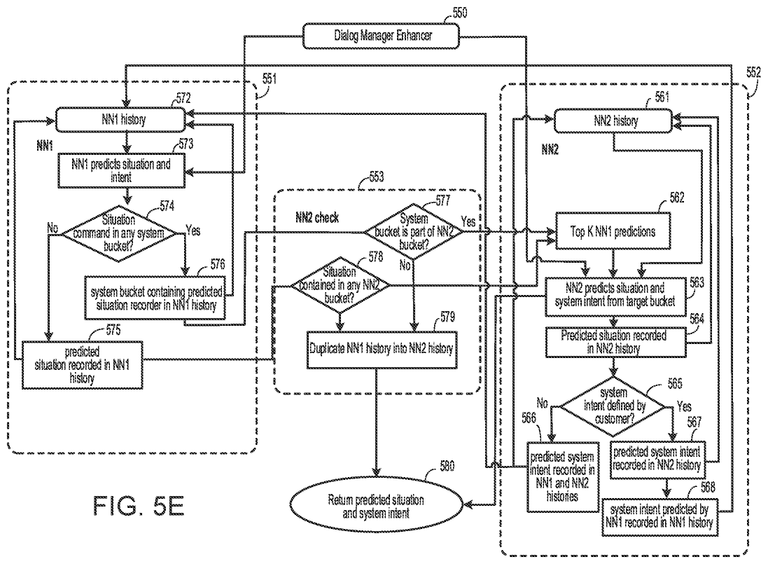

FIGS. 5a and 5b and 5c illustrate several scenarios of generation of situational buckets.

A situational bucket is a data structure that contains several situations. The situations are nuances of a more general situation. The bucket may contain only system situations, or a mix of system and customer situations. A special bucket—Other_Customer_Situation_Bucket—encapsulates all Customer Situations of a specific customer, in order to keep NN1 (humanized model) unaware of customer situations, and to facilitate NN1 a default situation when it cannot predict a system situation with enough certainty.

FIG. 5a illustrates the creation of a system bucket, and the scenario that causes its inclusion in a NN2 bucket. Steps 501-504 are NN1 steps and steps 505-508 are customer specific steps.

In step 501, new SystemGreeting1 situation is defined by the system. At this point, it is the only situation of its kind.

In step 502, a similar situation, SystemGreeting2, is created by the system. Since this is the second situation that is related to “Greeting”, and there is an overlap with SystemGreeting1 situation, a system bucket SystemGreetingBucket is created in step 503.

In step 504, SystemGreeting1 and SystemGreeting2 are mapped into SystemGreetingBucket with the system buckets hash table.

In step 505, a customer of the system creates his own greeting situation—CustomerGreeting.

Following this action, because an overlap with one or more situations in SystemGreetingBucket was identified in step 506, the system creates in step 507 a new NN2 bucket CustomerGreetingBucket that includes CustomerGreeting 1 and SystemGreetingBucket from step 504.

SystemGreetingBucket is mapped into CustomerGreetingBucket with the All buckets hash table.

The “Humanized model” NN1 is not re-trained with the new situation, but in order to perform the prediction process properly, in step 508 “bucket mapping” is added to the customer's contextual shell.

FIG. 5b illustrates the case where a customer defines a situation that overlaps with another situation already defined by the system and which is not a part of a System Bucket.

In step 511, the system creates the situation SystemWait.

In step 512, a customer creates the situation CustomerWait, which overlaps with SystemWait.

The system recognized this similarity in step 513, and in step 514 creates WaitBucket NN2 bucket, and adds to it both SystemWait and CustomerWait.

In step 515, SystemWait is mapped into WaitBucket by the All buckets hash table, and the “bucket mapping” is added to the customer's contextual shell.

FIG. 5c illustrates using the mechanism of buckets.

Block 521 illustrates the following overlaps between situations:

System situations SS1 and SS2 overlap with each other, and Customer scenarios also overlap with each other.

CS1 was mapped to SS1, and CS2 was mapped to SS2.

There is a need to decide (step 522) who will be responsible to resolve the conflict: the system or the customer.

The first option, as shown in block 523, is to resolve the conflict by the system during the design phase:

A new situation—SS3—is created, and it is assured that it does not overlap with SS1 nor with SS2.

Then, as shown in block 524, CS2 and SS2 are mapped into NN2 bucket 2.

Block 525 illustrates that CS1, along with the system situation SS3 that it is now mapped to, are mapped together into NN2 bucket 1.

During runtime, NN2 will need to resolve a “simple” conflict of one system situation and one customer situation from a situational bucket.

The second option is to leave the more complex resolution in real time to the customer model NN2.

Block 526 illustrates the actions required for this option.

SS1 and SS2 are mapped together into a system bucket. Then, the new system bucket along with CS1 and CS2 is mapped into a new NN2 bucket.

If this solution is selected, the customer will need to train NN2 with scenarios that represent the conflicting situations, so it will be able to resolve the conflict in real time.

The following is a “stop” example with reference to FIG. 5C:

Two system situations that are common for many voice applications and that are known to occur regularly even before a customer begins designing a voice application are:

1. SS1: Wait—pauses the conversation

2. SS2: Stop-end—stops the conversation

SS1 and SS2 are known for overlap (potential ambiguation), but during runtime, NN1, based on user intent stop (e.g. user utterance is “please stop”), history and context, should be able to distinguish between SS1 and SS2.

During the design/development of the customer application, customer defines 2 situations CS1 and CS2 to handle the potential user utterance of “stop”

1. CS1: Stopping long reading/playing long text (e.g. a disclaimer).

2. CS2: Customer Stop-end During simulation (part of the design phase) the system identifies the overlap and maps to SS1 and SS2 (1)

2 options for resolutions:

1. create a system bucket for SS1 and SS2 (ready for all similar customer side future ambiguations), map it to one NN2 bucket for all 4 options. During runtime NN2 may resolve the conflict or, if not, customer's logic using either CS1 or CS2 can be used to respond to the user.

2.

a. The system can identify this common conflict/ambiguity and create a system situation SS3, for pausing during a long read, or if the conflict/ambiguity is new, then the system can create a new SS3.

b. If new, NN1 is retrained with the new SS3, for all future customers' voice applications.

c. During a new customer's NN2 training and simulation CS1 and SS3 are mapped to a new NN2 bucket 1, and CS2 and SS2 are mapped into a new NN2 bucket 2.

During runtime, when user says “stop”, NN1 will distinguish between SS1, SS2, or SS3 and the bucketization will pass it to NN2

FIG. 5d is a block diagram illustrating the main components and processes in the DMW.

DMW 7 has several inputs 531:
Contextual shell data 532
Audio signal 533
CRM 534
NLU 535: User intent user sentiment and slots data are the most common outputs of the NLU
ASR data 536, that can come from several ASR modules

These inputs are used by DMW 7 for:
Conversational triggers calculation 538
User EQ calculation 539

The results of these calculations are processed and stored in conversational context 540.

The SCM sub-system 541 includes two models, preferably based on Seq2seq neural networks: NN1 542, the humanized model, and NN2 545—the customer model.

NN1 module includes its history 543, and NN2 module includes its history 546. NN1/NN2 history refers to inputs and outputs to previous turns/previous calls to NN1/NN2. Parts of history become parts of input for the current turn.

In step 544, NN1 humanized model 542 predicts, based on the model inputs and its history, the situation and system intent for generating the coming system side utterance. The predicted situation and system intent are either returned in step 548, or passed to NN2 545, in case that NN1's prediction is part of a NN2 bucket.

In case that control is passed to NN2, this module is responsible for predicting situation and system intent, based on the conversational context 540, its history 546, and the input it received from NN1.

As will be explained in FIG. 5e, if NN1 passes control to NN2, it will always send a situational bucket that NN2 will need to choose in step 547 the preferred situation and system intent out of it.

The predicted situation and intent are returned in step 548.

FIG. 5e is a detailed flowchart of the algorithm that runs in the SCM sub-system for predicting the situation and intent to be used by the system for optimally generating its next utterance. This flowchart focuses on the way the SCM resolves cases where a predicted situation is part of a situational bucket.

A few notes:

NN1 is not aware of (i.e., does not receive inputs from) NN2.
NN2 is aware of NN1 at least through the buckets mechanism described above.
All NN2 situations will go to a special bucket “Other_Customer_Situation_Bucket” which is the only (fixed) system situation NN1 is aware of.
NN2 handles the mapping between buckets and user or system defined situations.

As described in FIG. 5d, the Dialog Manager Enhancer 550 collects and organizes the data that is needed for SCM sub-modules NN1 551 and NN2 552 to make situation and system intent predictions.

NN1 551 also maintains its history 572 to be used in the prediction process. NN2 552 maintains its history 561 as well, for the same purpose.

After NN1 makes its prediction in step 573, the SCM checks in step 574 if the predicted situation is part of any system situational bucket, defined in the relevant contextual shell.

If it is, in step 576 the containing bucket is recorded in the history of NN1, and then in step 577 the SCM checks if this system bucket is part of a NN2 bucket.

If it does, control is passed to NN2, since this module is responsible to deal with customer situations.

If the bucket is not part of a NN2 bucket, in step 579 NN1 history is duplicated by the SCM into NN2 history, and in step 580 the predicted situation and intent are returned.

If the SCM decides in step 574 that the situation is not included in a system bucket, it records the situation in step 575 in NN1's history. Then it checks in step 578 if the situation is contained in a NN2 bucket.

If it is, control is passed to NN2.

If the predicted situation is not contained in any NN2 bucket, in step 579 NN1 history is duplicated by the SCM into NN2 history, and in step 580 the predicted situation and intent are returned.

In case that the control was passed from NN1 to NN2, the latter one receives in block 562 the top K NN1 predictions. Usually K will be equal to one, but it is possible that NN1 will pass to NN2 more than one situation.

Based on the input from NN1, the input from the DMW and its history, NN2 eventually predicts, in step 563, situation and system intent.

In step 564, the prediction is stored in the history of NN2 561, and in step 580 the predicted situation and intent are returned.

In step 565, NN2 checks if the predicted intent was defined by the customer. If it wasn't, the predicted system intent is recorded in step 566 in NN1 and NN2 histories.

If the intent was defined by the customer, the predicted system intent is recorded in step 567 in NN2 history, and in step 568 the system intent that was originally predicted by NN1 is recorded in NN1 history.

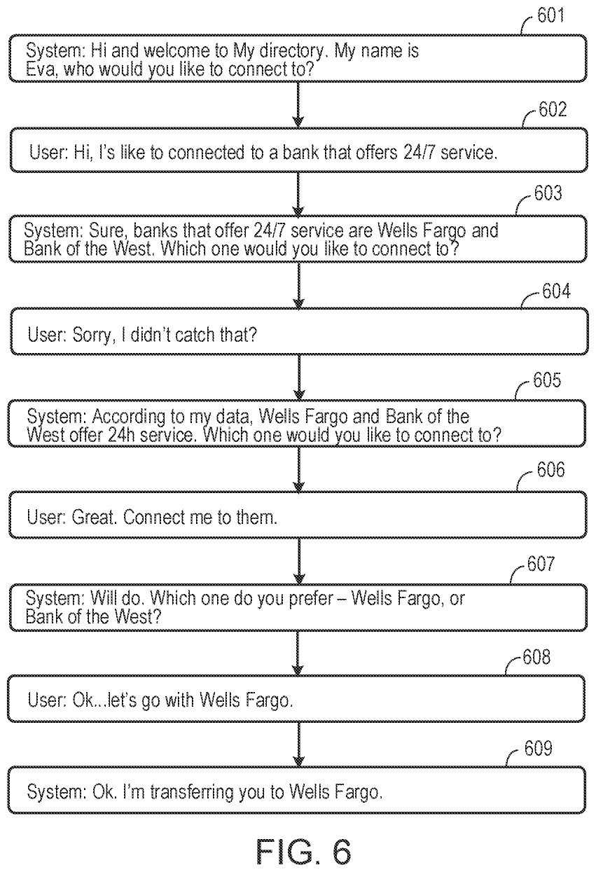

FIG. 6 is an example of a possible conversation between a user of the described system and a virtual assistant created by a customer of the system for handling banking related activities.

The conversation in FIG. 6 includes two user utterances, marked as 604 and 606, where the innovative capabilities of the described system allow it to respond with a sentence that is as close as possible to an intelligent human response.

Utterance 604: “Sorry, I didn't catch that?” would cause a VA to repeat its last response, maybe in a slower and clearer way.

Utterance 606: “Great, connect me to them” is an ambiguous answer of the user, causing the VA to try resolving the ambiguity.

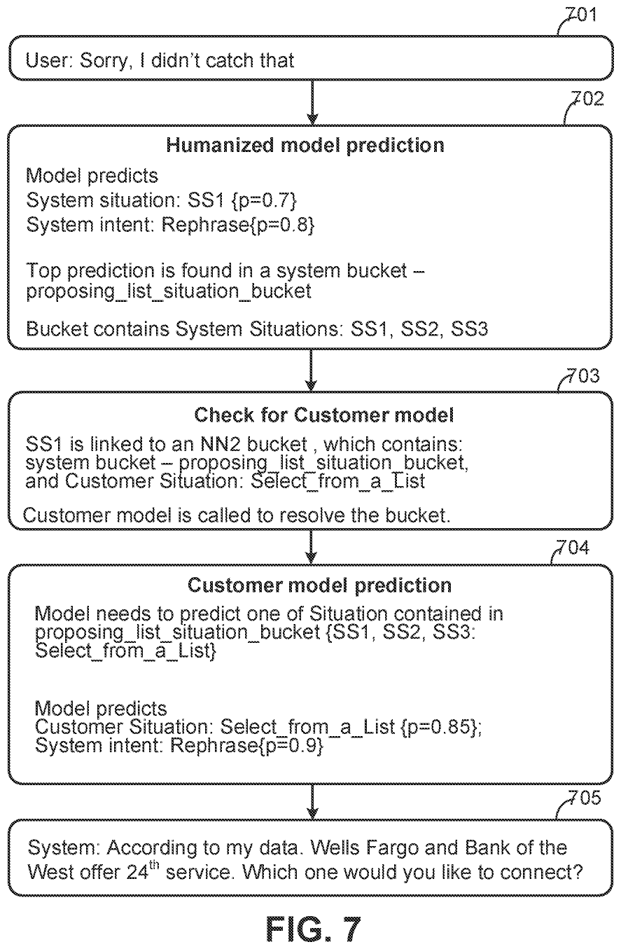

FIG. 7 shows the process that takes place in the SCM module for analyzing the current situation and predicting the right situation and intent, with utterance 604 of FIG. 6 as its input.

The Humanized model of the SCM sub-system predicts, in step 602 of FIG. 6, based on its input, that the situation SS1 with probability 0.7 and system intent Rephrase with probability 0.8 are the best candidates.

In step 702, the humanized model finds out that situation SS1 is contained in situational bucket proposing_list_situation_bucket, SB1.

This bucket, SB1, includes three possible System situations: SS1, SS2, SS3.

As described in step 577 of FIG. 5e, after it is established in step 3 that bucket SB1 maps to a NN2 bucket, the system passes the decision to the Customer model.

The Customer model makes its prediction in step 563 of FIG. 5e, to choose one of the situations contained in an NN2 bucket containing SB1 (situational bucket proposing_list_situation_bucket) and Customer situation Select_from_a_List

As shown in step 704 of FIG. 7, the system can determine to choose, from the bucket, the Customer situation Select_from_a_List, with probability 0.85. The predicted system intent Rephrase is saved as is, with probability 0.9.

After the SRG module's logic is activated, based on the prediction of the SCM module, in step 705 the most suitable DIR is chosen: “According to my data, Wells Fargo and Bank of the West offer 24 h service. Which one would you like to connect to?”, with the preferred realization of its variables which mainly cause the sentence to be repeated more slowly.

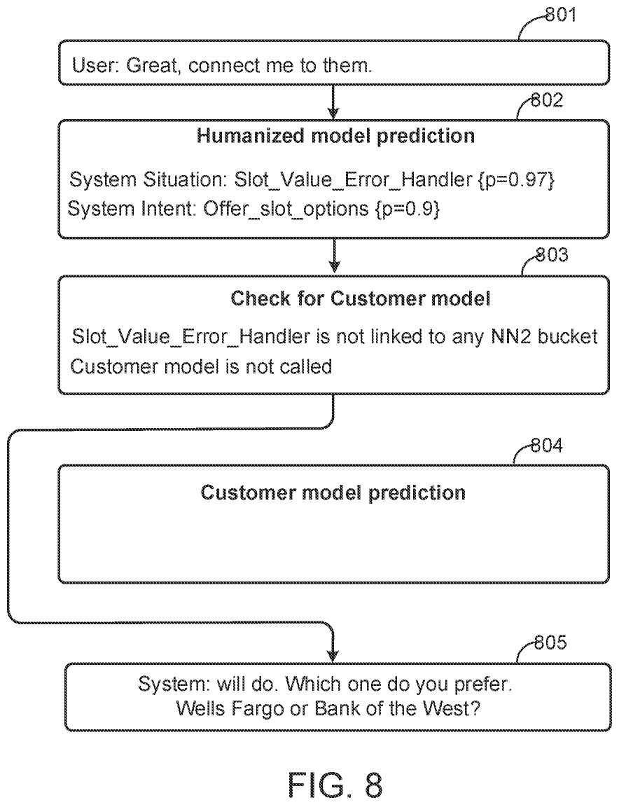

FIG. 8 shows another example of the process that takes place in the SCM module for analyzing the current situation and predicting the right situation and intent. In this case, utterance 606 of FIG. 6 acts as its input in step 801.

The Humanized model of the SCM sub-system predicts in step 802, (as described in step 606 of FIG. 6), based on the user's ambiguous input, that the situation is Slot_Value_Error_Handler with probability of 0.97, and the intent is Offer Slot Options with 0.9 probability. In step 803 the SCM decides, since Slot_Value_Error_Handler SS is not part of any NN2 bucket, not to call NN2 model.

Therefore, in step 804, After the SRG module's logic is activated, based on the prediction of the SCM module, the most suitable DIR is chosen: “will do. Which one do you prefer, Wells Fargo or Bank of the West?”. The system's solution for the ambiguous situation is to repeat in step 805 the options available for the user.

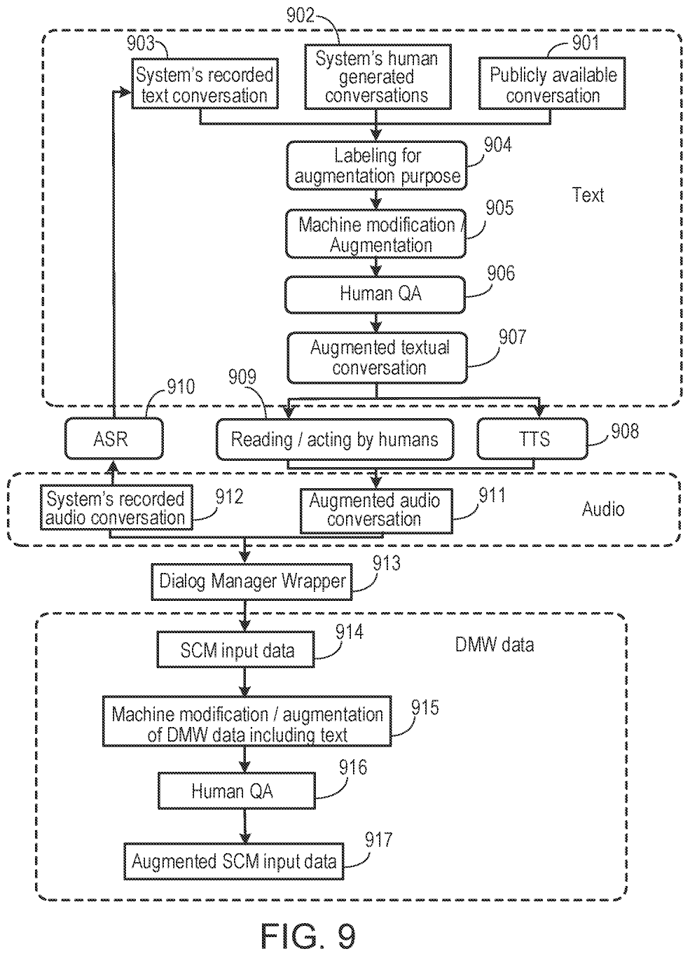

FIG. 9 describes the process of conversations data augmentation in the system, aiming to improve the training of the neural networks used by it.

Three types of data in the system may be augmented: textual conversations, audio conversations, and DMW data.

Publicly available conversations 901, system's human generated conversations 902 and system's recorded text conversations 903 are the initial text sources of the system.

In step 904, the system performs labeling of the textual conversations dedicated for the augmentation purposes. Labels categorize a (part of) sentence as being a specified part of a conversation. For example, “Hi/Hello” can be labelled as a greeting. Human-generated conversations are simulated or augmented conversations created by a human but not part of a recorded conversations. In step 905, the system automatically performs content modification and augmentation.

In step 906, the augmented content is checked and improved by human QA, and then the ready augmented conversations 907 are added to the system datasets.

Since the system is able to handle both textual and audio conversations, there is a need to transform the augmented content from text to audio as well. This is done either by TTS in step 908, or by human reading and acting in step 909.

In step 911, the generated audio content is added to the dataset of audio conversations.

The process of translation from one content type to another for augmentation purposes may also be the opposite one, from audio to text. System recorded audio conversations 912 may be passed to ASR 910, converted to text and then stored as part of the textual dataset, as part of system's recorded text conversations 903.

Another aspect of the augmentation process is enriching the data that the DMW prepares as input for its SCM module.

DMW 913 gets the augmented audio conversations and based on them prepares SCM input data 914. This data is modified and augmented automatically in step 915, and passes human QA in step 916. Then the augmented SCM input data 917 is added to the SCM datasets.

DIR (Dynamic Intelligent Response) Template Editor

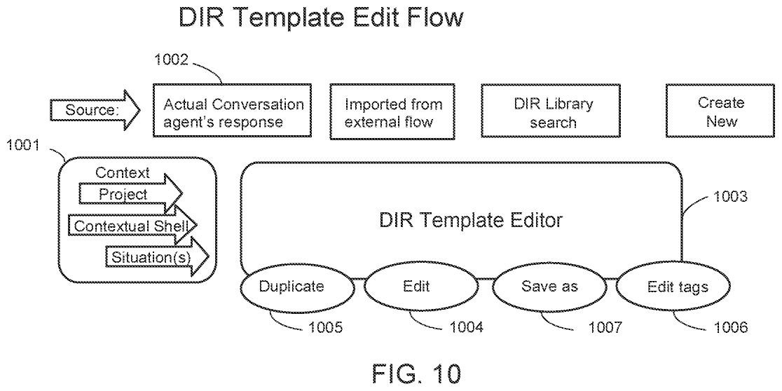

FIG. 10 describes the possible ways to create and edit a DIR template in the system. DIR templates are managed within the context 1001 of a specific situation and built into the SRG model of a specific conversational voice application. DIR temples may be generated automatically from actual conversations, imported from external dialog flow design systems, imported from existing DIR template libraries, or created manually from scratch. Within the DIR template editor 1003, a DIR template can be edited 1004 or duplicated 1005 and saved as new 1007. VUX designers may also edit the DIR tags, such as System Intents or rules, 1006.

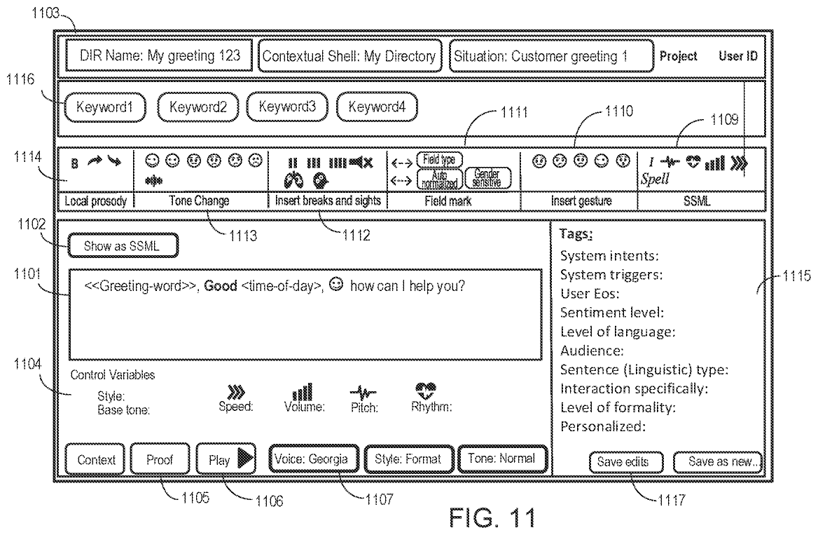

FIG. 11 shows a screen of a DIR template editor and the DIR template general structure. The DIR template editor main working area 1101 showing the DIR template in editing, comprised of one part-of-speech variable <<Greeting-word>>, e.g., “Hello”, one general variable <time-of-day>, e.g., “morning”, one tone change, to “happy”, an emphasis instruction on the word “good” and fixed text. Part-of-speech may be any valid phrase and may be simple or complex. One textual realization of the DIR template at the SRG phase during runtime, may be “Welcome, and good afternoon, how can I help you?” and the voice realization will include emphasis on the word “good” and “how can I help you?” would be synthesized with a happy tone. The DIR template designer can toggle the view between Speech Synthesis Markup Language (SSML) and text using button 1102. DIR template has a unique name and belongs to specific situation and contextual shell, 1103. At any point, a designer can simulate the behavior of the DIR template, and proofing it in the context by selecting button 1105, realizing the basic control variables 1104: speed, pitch-level, volume, and rhythm and realizing all the variables with valid possible values. Pressing the play button 1106, the user can listen to the actual DIR in the context. For additional simulations a user can manually change the TTS voice, 1107, and various other values.

In addition to plain text, part-of-speech variables, and simple variables, while editing a DIR template, the designer can add in-line prosodic instructions and values. These inline instructions may be fixed or variable (i.e., variable instructions are instructions the SRG realizes during runtime).

Inline prosodic instructions include:
1109, SSML local instructions with values: Spell, IPA pronunciation, rhythm, speed, volume, and pitch, e.g., “change speed to 80%”, “change speed to <speed value>” or “change speed to <Normal>
1110, audible gestures, like: Hmmm, Ahah, Ummm, coughing, etc.
1111, variables as described above
1112, break and sighs
1113, tone change instructions
1114, convenience prosodic instructions, such as tone raise, tone down and emphasis

Designers can edit the DIR template tags and labels, 1115. These tags are part of the DIR parameters that are trained into the SRG model and can be created automatically, e.g., from real conversations, suggested during simulation or edited manually. Designers can also add for future maintenance convenience searchable key words 1116. Once satisfied with the DIR template, designers can save the changes 1117.

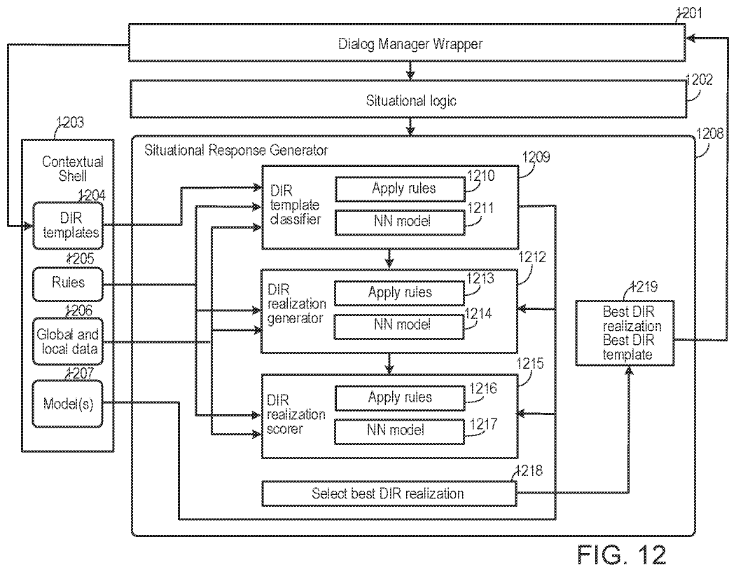

FIG. 12 is a flowchart of the algorithm that runs in the Situational Response Generator (SRG) sub-system for choosing the best DIR realization due to the context and the SCM situation and intent prediction.

After the SCM sub-module of DMW 1201 prepared its prediction, it is used as the input of Situational logic 1202, and passed to SRG 1208. Situation Logic module manages event flow within a specific situation. This module executes a set of rules to transition through a situation state machine based on input provided to the Situation Logic module as well as results of queries to external systems. While transitioning through the state machine the module emits preconfigured events and collects responses. Situation Logic module can be unique per situation or templatized.

In block 1209, the SRG first applies relevant mandatory rules based on Rules 1210 from contextual shell 12013. Then it activates the DIR template classifier module 1211. The two joined NN models are activated, based on NN data stored in block models 1207. One of them gets as input context's global and local data 1206 stored in contextual shell 3, and the second gets candidate DIR templates 1204, also from contextual shell 1203.

The output of DIR template classifier module of block 1209 is a set of the best DIR templates, and it goes to block 1212.

In block 1212, the SRG applies relevant mandatory rules based on Rules 1210 from contextual shell 1203. Then it activates the DIR realization generator module 1214. The NN model is activated, based on NN data stored in block models 1207. The NN model gets as input context's global and local data 1206 stored in contextual shell 1203.

The output of DIR realization generator module of block 1214 is a set of the same DIR templates it received from DIR template classifier module of block 1209, but with all variable fields replaced by multiple sets of real values from the corresponding variables' domains.

In block 1215, the SRG first applies relevant mandatory rules based on Rules 1210 from contextual shell 1203. Then it activates the DIR realization scorer module 1217. The two joined NN models are activated, based on NN data stored in block models 1207. One of them gets as input context's global and local data 1206 stored in contextual shell 1203, and the second gets the DIR realizations received from DIR realization generator module of block 1214.

Final score for each candidate DIR realization is produced, which SRG uses to predict its final DIR realization 1218.

Finally, in step 1219 the DIR with the best scored realization is selected to be used in the next system side utterance in the conversation. It is sent along with the corresponding DIR template to DMW 1201 to be stored and used later as part of the context.

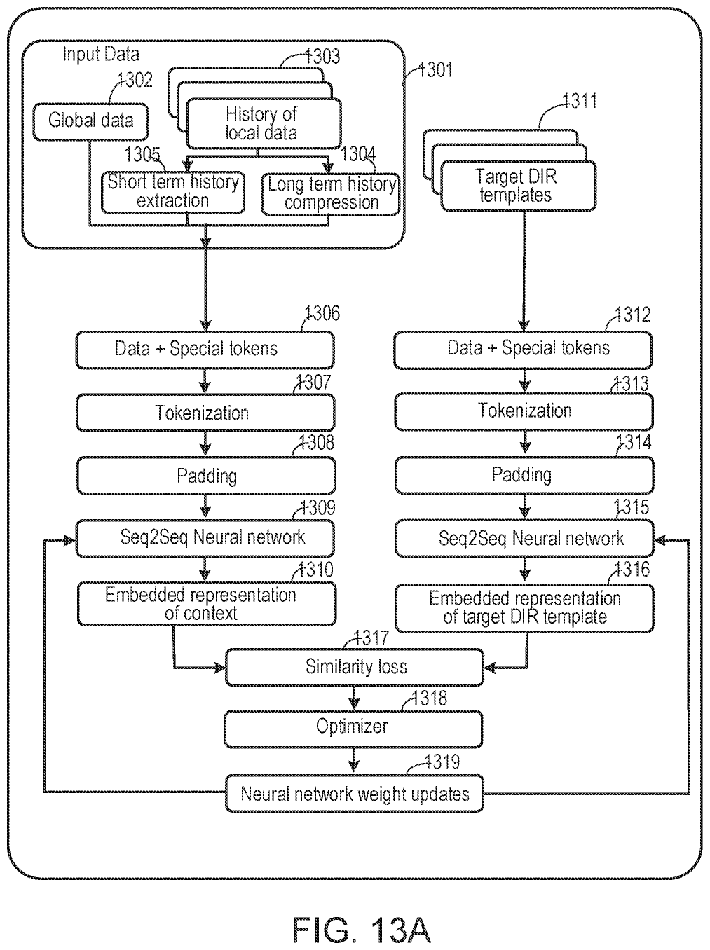

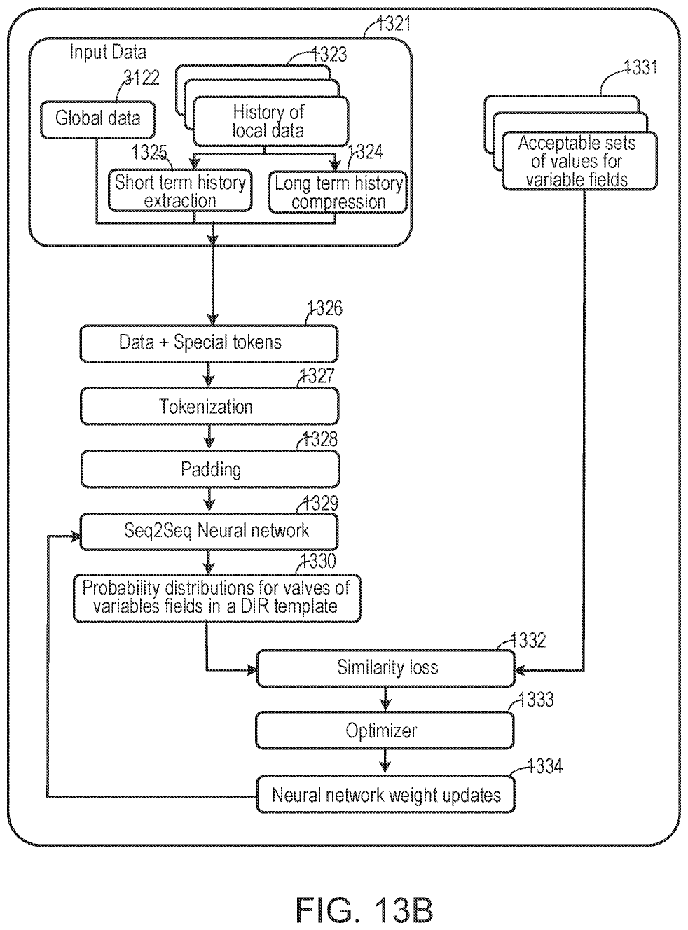

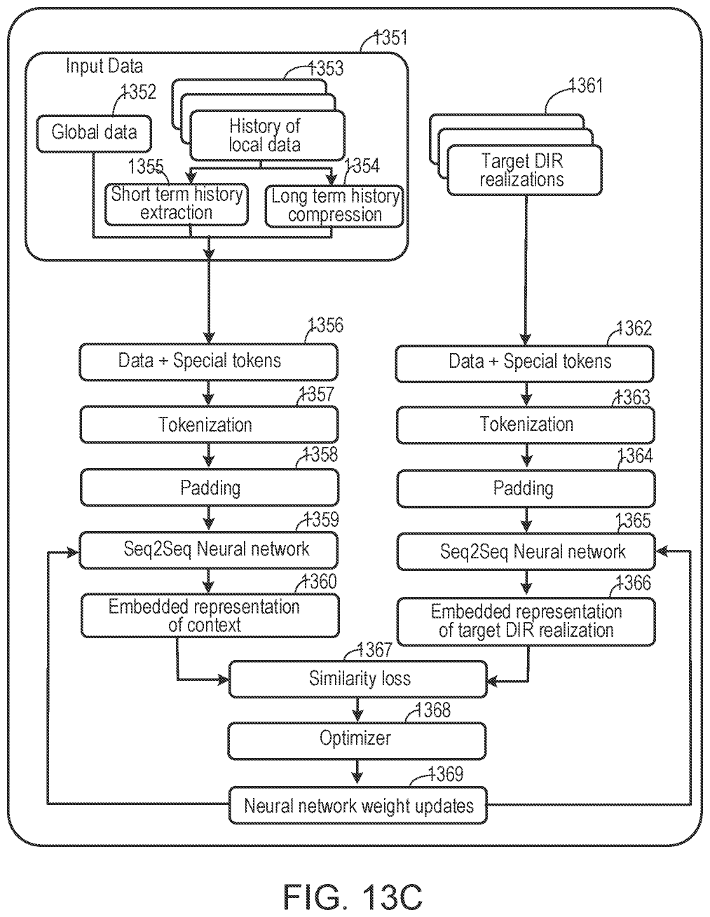

FIG. 13a is a flowchart of the training process of the DIR template classifier sub-module of the Situational Response Generator (SRG).

This module uses two joined sequence-to-sequence neural network models, each producing embedded representation of its input sequence.

The first NN model takes the current context as its input.

Input data 1301 includes two types of data, related to the training conversations: local data 1303 and global data 1302.

Global data 1302 contains all data that does not change between conversation turns, or data which does not have history in the system, such as the age and gender of a user or CRM data related to him.

On the other hand, local data 1303 is the dynamic data which may change during conversation turns, such as user EQ, user intent and audio parameters. There may be several sets of local data history, each of them related to a different turn in a training conversation.

During the training process, for efficiency reasons, a step of long term history compression 1304 is executed in order to keep all conversation history in a compressed form.

At the same time, a step of short term history extraction 1305 is executed, in order to make the short term history data available for the training process.

The rest of the process described in the steps 1306 to 1310 of FIG. 13a is a standard training process of a machine learning model, based on the Seq2seq popular model which is used many times in NLP applications. It should be noted that there is no restriction of using any other alternative type of machine learning model, that can fulfill the requirements of this patent.

In step 1306, the conversational text along with the global and local data which is relevant for the training session is pre-processed and special tokens are inserted into it.

Afterwards, the steps of tokenization 1307 and padding 1308 are also executed to make the data ready for the training phase.

Seq2seq neural network 1309 is activated, and in step 1310 the embedded representation of the context is prepared.

The second NN uses target DIR templates 1311 as inputs.

In step 1312, the data related to the acceptable DIR templates is pre-processed and special tokens are inserted into it.

Afterwards, the steps of tokenization 1313 and padding 1314 are also executed to make the data ready for the training phase.

Seq2seq neural network 1315 is activated simultaneously with NN 1309.

In step 1316, the embedded representation of the target DIR templates is prepared.

The two representations prepared by the two NNs in steps 1310 and 1316 are compared using a similarity metric. This way each acceptable DIR template is compared to the current context.

Based on that, similarity loss is calculated in step 1317, and the optimizer makes its calculations in step 1318 to update in step 1319 the joined NNs weight metrics for the next iteration.

Steps 1306 to 1310, 1312 to 1316 and 1317 to 1319 are iterated as was defined in the setup of the training process.

FIG. 13b is a flowchart of the training process of the DIR realization selector sub-module of the Situational Response Generator (SRG).

This module maps a DIR template to a DIR realization by filling in variable fields of a DIR template.

It is run for top K DIR templates predicted by DIR template classifier. Each DIR template is run (along with the context) through a sequence-to-sequence neural network model.

Input data 1321 includes two types of data, related to the training conversations: local data 1323 and global data 1322.

Global data 1322 contains all data that does not change between conversation turns, or data which does not have history in the system, such as the age and gender of a user or CRM data related to him.

On the other hand, local data 1323 is the dynamic data which may change during conversation turns, such as user EQ, user intent and audio parameters. There may be several sets of local data history, each of them related to a different turn in a training conversation.

During the training process, for efficiency reasons, a step of long term history compression 1324 is executed in order to keep all conversation history in a compressed form.

At the same time, a step of short term history extraction 1325 is executed, in order to make the short term history data available for the training process.

The rest of the process described in the steps 1326 to 1330 of FIG. 13b is a standard training process of a machine learning model, based on the Seq2seq popular model which is used many times in NLP applications. It should be noted that there is no restriction of using any other alternative type of machine learning model, that can fulfill the requirements of this patent.

In step 1326, the conversational text along with the global and local data which is relevant for the training session is pre-processed and special tokens are inserted into it.

Afterwards, the steps of tokenization 1327 and padding 1328 are also executed to make the data ready for the training phase.

Seq2seq neural network 1329 is activated, and in step 1330 the probability distributions for values of variable fields in a DIR template are prepared.

Then, by comparing the probability distributions to manually prepared acceptable sets of values for variable fields 1331, loss 1332 is calculated.

After two additional steps of optimizer 1333 and weight updates 1334, another iteration of training the NN with the updated weights is performed.

FIG. 13c is a flowchart of the training process of the DIR realization scorer sub-module of the Situational Response Generator (SRG).

The DIR realization scorer calculates similarity scores between context and candidate DIR realizations. It uses a similar NN architecture as the DIR template classifier, but is trained to use DIR realizations instead of DIR templates.

The first NN model takes the current context as its input.

Input data 1351 includes two types of data, related to the training conversations: local data 1353 and global data 1352.

Global data 1352 contains all data that does not change between conversation turns, or data which does not have history in the system, such as the age and gender of a user or CRM data related to him.

On the other hand, local data 1353 is the dynamic data which may change during conversation turns, such as user EQ, user intent and audio parameters. There may be several sets of local data history, each of them related to a different turn in a training conversation.

During the training process, for efficiency reasons, a step of long term history compression 1354 is executed in order to keep all conversation history in a compressed form.

At the same time, a step of short term history extraction 1355 is executed, in order to make the short term history data available for the training process.

The rest of the process described in the steps 1356 to 1360 of FIG. 13c is a standard training process of a machine learning model, based on the Seq2seq popular model which is used many times in NLP applications. It should be noted that there is no restriction of using any other alternative type of machine learning model, that can fulfill the requirements of this patent.

In step 1356, the conversational text along with the global and local data which is relevant for the training session is pre-processed and special tokens are inserted into it.

Afterwards, the steps of tokenization 1357 and padding 1358 are also executed to make the data ready for the training phase.

Seq2seq neural network 1359 is activated, and in step 1360 the embedded representation of the context is prepared.

The second NN uses target DIR realizations 1361 as inputs.

In step 1362, the data related to the target DIR realizations is pre-processed and special tokens are inserted into it.

Afterwards, the steps of tokenization 1363 and padding 1364 are also executed to make the data ready for the training phase.

Seq2seq neural network 1365 is activated simultaneously with NN 1359.

In step 1366, the embedded representation of the target DIR realizations is prepared.

The two representations prepared by the two NNs in steps 1360 and 1366 are compared using a similarity metric. This way each acceptable DIR realization is compared to the current context.

Based on that, similarity loss is calculated in step 1367, and the optimizer makes its calculations in step 1368 to update in step 1369 the joined NNs weight metrices for the next iteration.

Steps 1356 to 1360, 1362 to 1366 and 1367 to 1369 are iterated as was defined in the setup of the training process.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
using a first non-domain specific neural network based model to predict a non-domain specific conversational situation, the first neural network based model trained with labelled parts of conversations from more than one domain;
forwarding the non-domain specific conversational situation to a second domain specific neural network based model;
using the second domain specific neural network based model to predict a conversational situation and to provide a system intent, the second domain specific neural network based model trained with labelled parts of conversation from a specified domain; and
generating a response based at least in part on the predicted conversational situation and system intent.

2. The method of claim 1 wherein a situational conversation manager comprises the first non-domain specific neural network and the second domain specific neural network and wherein the method further comprises:
receiving processed text at a dialog manager wrapper, the processed text received from a natural language understanding module;
enriching the processed text with data retrieved from external sources to produce enriched processed text; and
forwarding the enriched processed text to the situational conversation manager.

3. The method of claim 1 wherein generating a response comprises:
determining, using a dynamic intelligent response template classifier, a set of best candidate dynamic intelligent response templates with a representation closest, according to a similarity metric, to a representation of a context of the conversation;
filling in, using a dynamic intelligent response realizer, variable fields for at least some of best candidate dynamic intelligent response templates to generate a set of dynamic intelligent response realizations;
scoring, using a dynamic intelligent response realization scorer, at least some of the set of dynamic intelligent response realizations based on closeness of the representation of a dynamic intelligent response realization, according to a similarity metric, to a representation of a context of the conversation to produce dynamic intelligent response realization scores; and
generating a response based at least in part on the dynamic intelligent response realization scores.

4. The method of claim 3 wherein a situational response generator comprises the dynamic intelligent response template classifier, dynamic intelligent response realizer and dynamic intelligent response realization scorer.

5. The method of claim 2 wherein the method further comprises determining user emotional quotient and providing that to the situational conversation manager

6. The method of claim 5 wherein the method further comprises determining behavioral triggers and providing that info to the situational conversation manager

7. The method of claim 6 wherein a dialog manager enhancer determines the user emotional quotient and the behavioral triggers, wherein a dialog manager wrapper comprises the dialog manager enhancer and the situational conversation manager and wherein the method further comprises receiving, at the dialog manager wrapper, contextual shell data.

8. The method of claim 7 wherein the contextual shell data comprises system contextual shell data and customer contextual shell data.

9. The method of claim 1 wherein forwarding the non-domain specific conversational situation to a second domain specific neural network based model comprises forwarding an initial system intent prediction.

10. The method of claim 1, the method further comprising:
determining that the prediction of a conversational situation is part of a system situational bucket;
determining that the system situational bucket is part of a customer specific bucket; and
based on determining that the system situational bucket is part of a customer specific bucket, using the second domain specific neural network based model to predict a conversational situation and to provide a system intent.

11. The method of claim 1, the method further comprising:
determining that the non-domain specific situation is part of a customer specific bucket; and
based on determining that a system situation is part of a customer specific bucket, using the second domain specific neural network based model to predict a conversational situation and to provide a system intent.

12. A system comprising:
one or more computers and one or more storage devices on which are stored instructions that are operable, when executed by the one or more computers, to cause the one or more computers to perform operations comprising:
using a first non-domain specific neural network based model to predict a non-domain specific conversational situation, the first neural network based model trained with labelled parts of conversations from more than one domain;
forwarding the non-domain specific conversational situation to a second domain specific neural network based model;
using the second domain specific neural network based model to predict a conversational situation and to provide a system intent, the second domain specific neural network based model trained with labelled parts of conversation from a specified domain; and
generating a response based at least in part on the predicted conversational situation and system intent.

13. The system of claim 12 wherein a situational conversation manager comprises the first non-domain specific neural network and the second domain specific neural network and wherein the operations further comprise:
receiving processed text at a dialog manager wrapper, the processed text received from a natural language understanding module;
enriching the processed text with data retrieved from external sources to produce enriched processed text; and
forwarding the enriched processed text to the situational conversation manager.

14. The system of claim 12 wherein generating a response comprises:
determining, using a dynamic intelligent response template classifier, a set of best candidate dynamic intelligent response templates with a representation closest, according to a similarity metric, to a representation of a context of the conversation;
filling in, using a dynamic intelligent response realizer, variable fields for at least some of best candidate dynamic intelligent response templates to generate a set of dynamic intelligent response realizations;
scoring, using a dynamic intelligent response realization scorer, at least some of the set of dynamic intelligent response realizations based on the closeness of the representation of a dynamic intelligent response realization, according to a similarity metric, to a representation of a context of the conversation to produce dynamic intelligent response realization scores; and
generating a response based at least in part on the dynamic intelligent response realization scores.

15. The system of claim 14 wherein a situational response generator comprises the dynamic intelligent response template classifier, dynamic intelligent response realizer and dynamic intelligent response realization scorer.

16. The system of claim 13 wherein the operations further comprise determining user emotional quotient and providing that to the situational conversation manager.

17. The system of claim 16 wherein the operations further comprise determining behavioral triggers and providing that info to the situational conversation manager.

18. The system of claim 17 wherein a dialog manager enhancer determines the user emotional quotient and the behavioral triggers, wherein a dialog manager wrapper comprises the dialog manager enhancer and the situational conversation manager and wherein the method further comprises receiving at the dialog manager wrapper contextual shell data.

19. The system of claim 18 wherein the contextual shell data comprises system contextual shell data and customer contextual shell data.

20. The system of claim 12 wherein forwarding the non-domain specific conversational situation to a second domain specific neural network based model comprises forwarding an initial system intent prediction.

21. The system of claim 12, the operations further comprising:
determining that the prediction of non-domain specific situation is part of a system situational bucket;
determining that the system situational bucket is part of a customer specific bucket; and
based on determining that the system situational bucket is part of a customer specific bucket, using the second domain specific neural network based model to predict a conversational situation and to provide a system intent.

22. The system of claim 12, the operations further comprising:
determining that the non-domain specific situation is part of a customer specific bucket; and
based on determining that the system situation is part of a customer specific bucket, using the second domain specific neural network based model to predict a conversational situation and to provide a system intent.
